(19) United States
(12) Patent Application Publication
(10) Pub. No.: US 2024/0311459 A1
(43) Pub. Date: Sep. 19, 2024

(54) ACCESS CONTROL DEVICE

(71) Applicant: INTERMAN Corporation, Kagoshima-shi, Kagoshima (JP)

(72) Inventor: Shigeki UETABIRA, Kagoshima-shi (JP)

(73) Assignee: INTERMAN CORPORATION, Kagoshima-shi, Kagoshima (JP)

(21) Appl. No.: 18/578,155

(22) PCT Filed: Jun. 24, 2022
(86) PCT No.: PCT/JP2022/025247

§ 371 Date: Jan. 10, 2024

(30) Foreign Application Priority Data
Jul. 15, 2021 (JP) 2021-117476

(51) Int. Cl. G06F 21/32

(52) U.S. Cl. CPC G06F 21/32

(57) ABSTRACT

[Problem] To provide an access control device that controls access to operation means such as switches and push buttons.

[Abstract] The access control device covers the operation means and prevents access to this means. This access control device is equipped with an authentication device, and if a user is successfully authenticated by this authentication device, access to the operation means is allowed to this user and the operation means can be operated. For example, this operation means is a push button, and the access control device has another push button superimposed on this push button and controls access to the push button as an operation means by controlling an engagement means that engages this other push button.

### FIELD OF THE INVENTION

The present invention relates to an access control device that controls access to operation means such as switches, push buttons or the like.

### BACKGROUND TECHNOLOGY

In order for people to live their daily lives, there is a need to operate switches in various situations. For example, when commuting by car, it is necessary to press the start switch of the automobile. Also, when going to an office in a building, there may be a need to operate an elevator switch. Furthermore, in order to enter an office room, it may be necessary to operate an entrance key or the like.

### PRIOR ART LITERATURE

### Patent Document

[Patent Document 1] Japanese Patent Published Application No. 2016-145480

### SUMMARY OF THE INVENTION

### Problem to be Solved by the Invention

In such cases, normally, anyone can operate these switches without any problem. In order to prevent this operation from being performed by anyone other than authorized persons, it is necessary to incorporate an appropriate authentication device from the beginning.

Patent Document 1 discloses an unlocking auxiliary device for easily using a conventional lock, which is locked and unlocked using a metal key installed on a door, as an electronic lock. With this unlocking auxiliary device, registered users can easily unlock the door with a smartphone or the like without using a special key.

Also, this unlocking auxiliary device can be installed by post-installation if the lock is equipped with a thumb turn. However, this unlocking auxiliary device is not available for other types of switches, such as push buttons and rocker switches, which do not have thumbturns.

Furthermore, since the unlocking auxiliary devices described in Patent Document 1 are installed inside the door, it is not possible to use high-security authentication methods such as biometric authentication.

It is therefore an object of the present invention to provide an access control device that can be installed on various types of switches such as push buttons and rocker switches.

Furthermore, it is another object of the present invention to provide a more secure access control device.

### Means to Solve the Problems

To achieve at least one of the above-mentioned objects, reflecting one aspect of the present invention, an access control device covers an operation means to prevent access to this operation means, wherein the access control device is characterized in that the access control device is equipped with an authentication device, and if a user is successfully authenticated by this authentication device, access to said operation means is allowed to this user and the user is able to operate said operation means.

In accordance with one embodiment, the access control device is characterized in that said operation means is a first push button, that said access control device includes a second push button provided to hide said first push button and superimposed on said first push button, and an engagement means that engages said second push button and prevents its pressing, and that, if the user is successfully authenticated by said authentication device, said engagement means disengages said second push button and enables pressing of said second push button, and further enables pressing of said first push button by said second push button.

In accordance with another embodiment, the access control device is characterized in that said authentication device is a finger vein authentication device.

In accordance with a further embodiment, the access control device is characterized in that the access control device is equipped with a lid member and an opening/closing apparatus that controls the opening and closing of the lid, and if the user is successfully authenticated by said authentication device, said opening/closing apparatus opens the lid member to allow access to said operation means.

### Effect of the Invention

In accordance with the access control device of the present invention, it can be installed on various switches such as push buttons and rocker switches to provide access control with higher security.

### BRIEF DESCRIPTION OF DRAWINGS

FIG. 1 is a plan view of an access control device 10 of an embodiment 1 of the present invention.

FIG. 2 is a cross section view along A-A line of FIG. 1, showing the access control device 10 of the embodiment 1 of the present invention.

FIG. 3 is a cross section view of an automobile with the access control device 10 of the embodiment 1 of the present invention with a start switch 20 of the automobile being pressed down.

FIG. 4 is a plan view of an access control device 50 in accordance with an embodiment 2 of the present invention.

FIG. 5 is a cross section view along A-A line of FIG. 4 showing the access control device 50 in accordance with the embodiment 2 of the present invention.

FIG. 6 is a cross section view along B-B line of FIG. 4 showing the access control device 50 in accordance with the embodiment 2 of the present invention.

FIG. 7 is a cross section view along B-B line of FIG. 4 showing the access control device 50, with a lid member being open, in accordance with the embodiment 2 of the present invention.

### DESCRIPTION OF EMBODIMENTS

### Embodiment 1

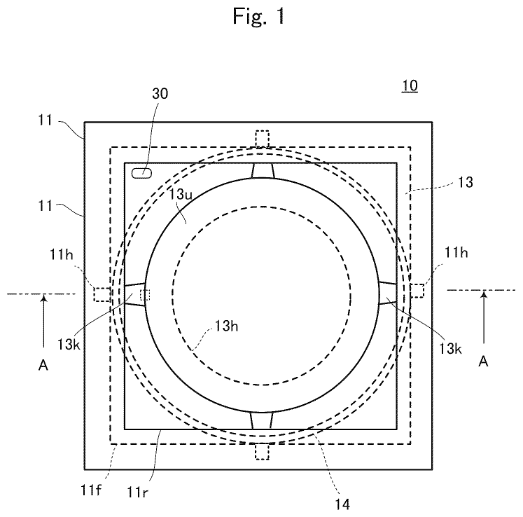

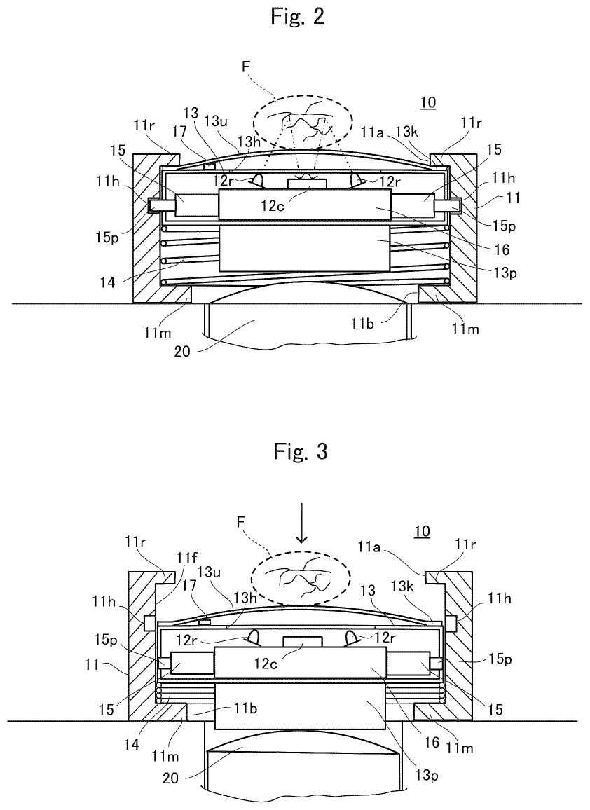

Hereinafter, an embodiment 1 of the access control device in accordance with the invention is described with reference to the accompanying drawings. FIG. 1 is a plan view of the access control device 10 of the embodiment 1. Also, FIG. 2 is a cross section view along A-A line of FIG. 1 showing the access control device 10 in accordance with the embodiment 1 of the present invention. Furthermore, FIG. 3 is a cross section view along A-A line of FIG. 1 showing the access control device 10 activated in accordance with the embodiment 1 of the invention in operation.

This access control device 10 is used to cover any push button. Here, an example will be described in which the access control device 10 is installed on a start switch 20 of an automobile. For installation, a strong double-sided tape can be used to affix the access control device 10 to the surface surrounding the start switch 20.

As shown in the figure, the access control device 10 consists of a hollow box-type housing 11 with openings 11a and 11b at the top and bottom, a push button 13 that is slidable up and down inside the housing 11 and contains a finger vein authentication device to be described below, and a spring 14 that forces the push button 13 upward. Further, a pressing member 13p is provided at the bottom of the push button 13 at a position facing the start switch 20 of the automobile.

On the other hand, at the top of the push button 13, there is an opening 13h and a spherical lid member 13u that transmits near-infrared light. The lid member 13u is supported in a slightly upward floating state by support pieces 13k extending in horizontal and vertical directions, and can be moved up and down by deformation of the support pieces 13k. Further, a switch 17 is provided between the top surface of the push button 13 and the lid member 13u, and this switch 17 can be turned on by pushing the lid member 13u downward.

The edges of the openings 11a and 11b of the housing 11 have protruding stop brims 11r and 11m, respectively, which prevent the push buttons 13 provided inside from popping out in an upward or downward direction. The push button 13 is housed in the housing 11 so that it slides up and down along the inner surface 11f of the housing 11 between these stop brims 11r and 11m. The spring 14 is interposed between the lower surface of the push button 13 and the stop brim 11m, and forces the push button 13 upward. In the standby state, the elasticity of this spring 14 keeps the push button 13 in contact with the stop brim 11r.

Inside the housing 11, in addition to the finger vein authentication device, there is provided solenoid actuators 15. In the position where the push button 13 contacts the stop brim 11r, the solenoid actuators 15 have plungers 15p respectively protruding laterally to engage the engagement holes 11h formed on the inner surface of the housing 11.

When the plungers 15p of the solenoid actuators 15 are engaged with the engagement holes 11h formed on the inner surface of the housing 11, the push button 13 cannot be pushed down even if pressed from above with a finger. By operating the solenoid actuators 15 and pulling the plungers 15p back toward the center to release the engagement between the plungers 15p and the engagement holes 11h, the push button 13 can be pushed down with a finger from above.

The finger vein authentication device includes infrared LEDs 12r, an infrared sensor 12c, and a signal control unit 16 that controls these infrared LEDs 12r and infrared sensor 12c as well as performs processing required for performing finger vein authentication. The signal control unit 16 also drives the aforementioned solenoid actuators 15. For simplicity, details of the signal control unit 16, necessary wiring, power supply, etc. are not illustrated.

The finger vein authentication device authenticates the finger vein pattern of a finger placed on the lid member 13u of the push button 13. That is, when a finger F is placed on the lid member 13u of the push button 13, the support pieces 13k are deformed so that the lid member 13u is slightly lowered to turn on the switch 17. This activates the signal control unit 16 to control the finger vein authentication device for performing finger vein authentication. Specifically, the infrared LEDs 12r are energized to irradiate the finger F placed on the lid member 13u of the push button 13 with near-infrared rays. The near-infrared rays returned from the finger F are then detected by the infrared sensor 12c.

That is, when the near-infrared rays emitted from the infrared LEDs 12r pass through the lid member 13u and penetrate the inside of the finger F, deoxyhemoglobin in the blood absorbs the near-infrared rays, so that the veins of the finger become shadows. The finger vein pattern is then photographed by the infrared sensor 12c and acquired as an image signal. The acquired image signal is processed for performing general finger vein authentication by the signal control unit 16.

When the finger vein authentication process successfully authenticates the user and confirms that the user is a registered user, the signal control unit 16 drives the solenoid actuators 15 to pull the plungers 15p back in the center direction to disengage the engagement between the plungers 15p and the engagement holes 11h. As a result, as shown in FIG. 3, a finger pushes down the push button 13, and furthermore, the pressing member 13p pushes down the start switch 20 to start the automobile.

Then, when the finger is removed from the lid member 13u, the push button 13 moves upward until it abuts on the stop brim 11r. At the same time, the switch 17 is turned off, the solenoid actuators 15 push out the plungers 15p, and the state of engagement between the plungers 15p and the engagement holes 11h is restored.

Next, a method of registering a finger vein pattern in the finger vein authentication device and editing or deleting the registered finger vein pattern will be explained. Here, an example will be described in which finger vein patterns are managed by a management server on the Internet.

The access control device 10 is provided with a USB port 30. After connecting a personal computer to this USB port 30, the finger vein pattern management software is started on the personal computer side. With the access control device 10 and the personal computer being connected, this finger vein pattern management software controls the infrared LEDs 12r and infrared sensor 12c of the finger vein authentication device, and registers, deletes, and edits finger vein patterns, which will be described later. Meanwhile, the USB port 30 is also used for the purpose of supplying power to the access control device 10.

First, a user's finger vein pattern is registered by placing the finger F on the lid member 13u of the push button 13 and controlling the infrared LEDs 12r and infrared sensor 12c via the personal computer to acquire the finger vein pattern of the finger F. The finger vein pattern management software then accesses a management server on the Internet.

This management server manages the registered finger vein patterns of each user, and when accessed by the finger vein pattern management software, it authenticates the user and permits login to My Page. After login, the finger vein pattern management software uploads the acquired finger vein pattern to the management server.

On the cloud side, the uploaded finger vein pattern is saved as a registered pattern for this user, and a signature for this finger vein pattern is returned. The finger vein pattern management software transmits this finger vein pattern and signature to the access control device 10 via USB. The access control unit 10 verifies that the signature is that of the management server, and if the verification is successful, this finger vein pattern is registered in the finger vein authentication device. From then on, this finger vein pattern is used to perform authentication of the finger vein authentication device, and it is possible to depress the start switch 20.

The finger vein pattern may be registered multiple times. That is, by performing user authentication on the management server and logging into the same My Page, a finger vein pattern of another person can be registered in the finger vein authentication device through the same procedure. Once registered, the user who has registered the finger vein pattern can press the start switch 20 of the automobile with almost the same usability as before, and no other person can press the start switch 20.

Deletion of registered finger vein patterns can also be performed by accessing the management server from the finger vein pattern management software. In this case, connection to the access control device 10 is not necessary. Namely, the deletion can be done by logging in to My Page on the management server from the finger vein pattern management software and specifying the finger vein pattern to be deleted.

In the above example, since the registration and deletion of the finger vein pattern are performed via the management server, it is possible to manage with high security. However, it is also possible to register and delete finger vein patterns locally without using the management server.

For example, a Bluetooth (registered trademark) communication function is implemented in the signal control unit 16 to enable communication with a smartphone. Furthermore, a dedicated application is installed on the smartphone, and this application is used to log in to the access control device 10 and perform finger vein pattern registration and deletion.

### Embodiment 2

Hereinafter, an embodiment 2 of an access control device according to the present invention will be described with reference to the accompanying drawings. This access control device is installed in such a way as to cover and hide the object to be controlled, such as a switch or button, so that it cannot usually be operated, and the object to be controlled can be accessed by opening a shutter provided on the top surface.

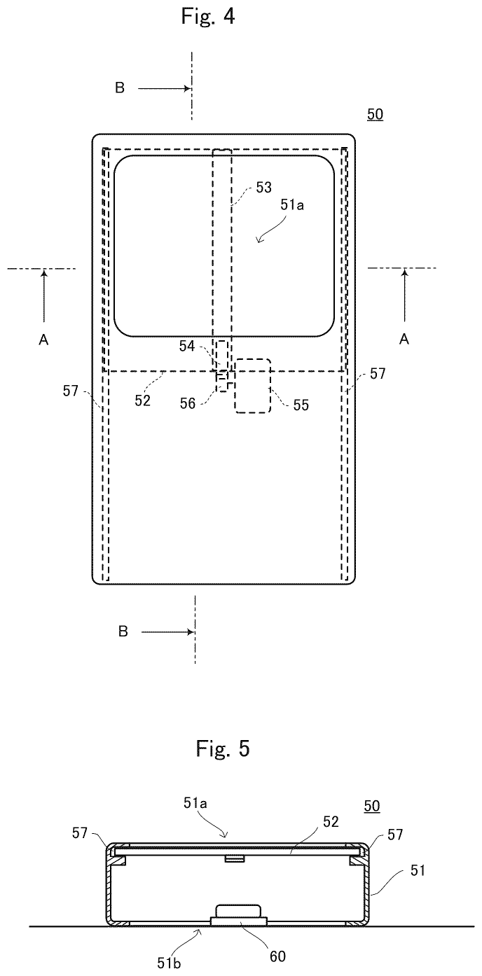

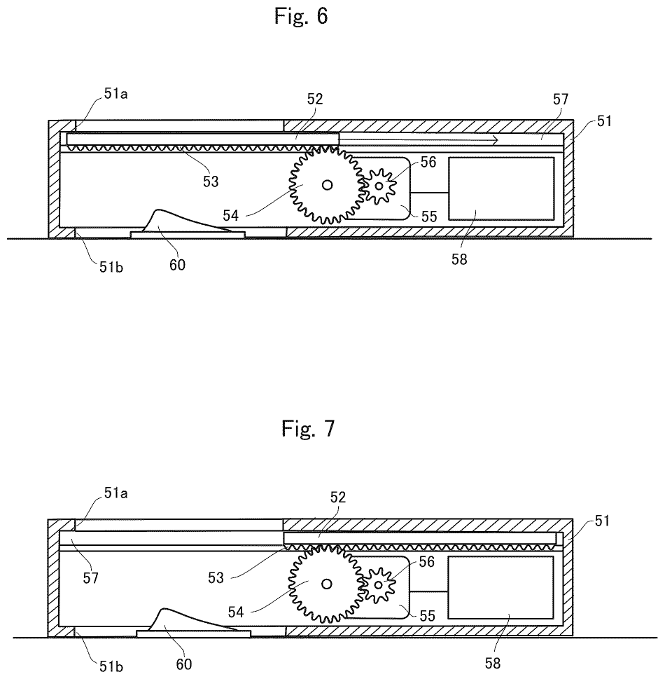

FIG. 4 is a plan view of the access control device 50 of the embodiment 2, and FIG. 5 is a cross section view along line A-A of FIG. 4. Also, FIG. 6 is a cross section view taken along line B-B of FIG. 4.

In the access control device 10 of the embodiment 1, a push button is mainly assumed to be the object to be controlled. However, the access control device 50 in the embodiment 2 can be applied to any type of control objects as long as the access control device 50 itself can be installed thereon. This example will be explained by installing the access control device 50 on the rocker switch 60. In the same manner as in the embodiment 1, a strong double-sided tape can be used for installation to affix the access control device 50 to the surface surrounding the rocker switch 60 also in the embodiment 2.

As shown in the figure, the access control device 50 includes a hollow rectangular housing 51 with openings 51a and 51b on the upper and bottom sides, and a lid member 52 that slides along a groove 57 formed at the upper end of the side of the housing 51. The openings 51a and 51b are located in the same position in the upper half of the housing 51. When the lid member 52 is closed (see FIG. 6), the opening 51a is completely blocked and the rocker switch 60 cannot be accessed. When the lid member 52 is open (see FIG. 7), the opening 51a is open, and the rocker switch 60 can be operated through the opening 51b.

In the middle of the back surface of the lid member 52, there is provided a rack 53 that is a toothed flat bar, and by the rotation of a pinion 54 engaged with this rack 53, the lid member 52 slides along the upper surface of the housing 51 to open and close the opening 51a. The pinion 54 is engaged with a gear 56, which is rotated by a motor 55. The motor 55 is driven by energization from a control circuit 58 to open and close the lid member 52 through the gear 56, the pinion 54 and the rack 53.

The control circuit 58 internally includes a power source, a wireless communication module, and a signal processing device. The wireless communication module is equipped with a function for short-range wireless communication, for example, such as Bluetooth (registered trademark). Further, the signal processing device executes authentication processing via the wireless communication module, authenticates the user as the partner of wireless communication, and opens the lid member 52.

This access control device 50 is used in the following procedure. First, a dedicated application is installed on a smartphone. This dedicated application can perform wireless communication with the access control device 50 and perform various settings. When the access control device 50 is set up, the dedicated application is used to perform Bluetooth (registered trademark) connection and user registration.

After user registration, the lid member 52 can be opened at any time using the registered smartphone. In other words, the dedicated application performs wireless communication with the access control unit 50, for example, by transmitting a user ID and password for user authentication. If the authentication is successful, the access control unit 50 opens the lid member 52 via the control circuit 58.

This allows the user to operate the rocker switch 60 through the openings 51a and 51b. After the rocker switch 60 is operated, the dedicated application can be operated again to close the lid member 52 via the control circuit 58. Alternatively, the system can be configured such that the lid member 52 is closed automatically when the Bluetooth (registered trademark) connection is lost (i.e., when the user leaves the area) after the lid member 52 is opened, without any special operation.

### INDUSTRIAL APPLICABILITY

In accordance with the access control device of the present invention, it can be installed on various switches such as push buttons and rocker switches to provide access control with higher security.

In the embodiment 1 above, the biometric information used in the access control device is a finger vein pattern as an example, but the present invention is not limited to this. For example, it is apparent that the present invention can be easily implemented even if fingerprints are employed as biometric information.

Also, in the above the embodiment 1, authentication is performed by directly touching the finger vein authentication device, but a non-contact finger vein authentication device may be employed in consideration of infectious diseases. Such a contactless finger vein authentication device is described in Patent Application No. 2020-117165 filed by the applicant.

### EXPLANATION OF SYMBOLS

10 access control device
11 housing
11a, 11b opening
11f inner surface
11h engagement hole
11r, 11m stop brim
2c infrared sensor
12r infrared LED
13 button
13h opening
13k support pieces
13p pressing member
13u lid member
14 spring
15 solenoid actuator
15p plunger
16 signal control unit
17 switch
20 start switch
30 USB port
50 access control unit
51 housing
51a, 51b opening
52 lid member
53 rack
54 pinion
55 motor
56 gear
57 groove
58 control circuit
60 rocker switch

1-5. (canceled)

6. An access control device that hides an operation device to prevent access to this operation means, comprising an authentication device, wherein, if a user is successfully authenticated by the authentication device, the access control device permits the user to access the operation device and operate the operation device, wherein the operation device is a first push button, and the access control device includes a second push button superimposed on the first push button to hide the first push button, and an engagement member that engages the second push button and prevents the second push button from being pressed down, wherein the access control device further comprises a finger detector that detects a finger placed on the second push button, and when the finger detector detects the finger placed on the second push button, the authentication device performs biometric authentication of the finger, and wherein, when the biometric authentication is succeeded by the authentication device, the engagement member releases the second push button which can thereby be pressed down by the finger so that the first push button can then be pressed down by the second push button.

7. The access control device as claimed in claim 6, wherein the finger detector is a switch which is pressed and turned on by the second push button to detect the finger when the finger is placed on the second push button which is then slightly lowered by the finger.

8. The access control device as claimed in claim 7, wherein the authentication device is a finger vein authentication device.
